(19) United States
(12) Patent Application Publication
(10) Pub. No.: US 2017/0262561 A1
(43) Pub. Date: Sep. 14, 2017

(54) INFORMATION PROCESSING APPARATUS, INFORMATION PROCESSING METHOD, AND RECORDING MEDIUM

(71) Applicant: NEC Corporation, Tokyo (JP)

(72) Inventor: Shinichiro YOSHIDA, Tokyo (JP)

(73) Assignee: NEC Corporation, Tokyo (JP)

(21) Appl. No.: 15/510,340

(22) PCT Filed: Aug. 20, 2015
(86) PCT No.: PCT/JP2015/004156

§ 371 Date: Mar. 10, 2017

(30) Foreign Application Priority Data
Sep. 11, 2014 (JP) 2014-185022

(51) Int. Cl. G06F 17/50; G06F 11/34; G06F 11/30

(52) U.S. Cl. CPC G06F 17/5009; G06F 11/3006; G06F 11/3495

(57) ABSTRACT

A system can be monitored with an appropriate model in accordance with the operating state of the system. An operation management apparatus (100) includes a model storage unit (121) and an analysis unit (110). The model storage unit (121) stores a plurality of models relating to monitoring data of a monitored system (500). The analysis unit (110) performs abnormality detection on newly acquired monitoring data by a main model that is one model among the plurality of models, performs abnormality detection on the newly acquired monitoring data by another model when abnormality is detected by the main model. The analysis unit (110) sets the another model as the main model for subsequently acquired monitoring data when abnormality is not detected by the another model.

### TECHNICAL FIELD

The present invention relates to an information processing apparatus, an information processing method, and a recording medium.

### BACKGROUND ART

An example of an operation management apparatus that performs modeling of a system by using time-series information about system performance and monitors the system by using a generated model is described in PTL 1.

Based on measured values of a plurality of metrics of a system, the operation management apparatus described in PTL 1 determines a correlation function that indicates a correlation for each pair in the plurality of metrics to generate a model of the system. Further, this operation management apparatus detects abnormality of the system by determining whether or not newly measured values of the metrics conform to the correlation in the generated model.

In the operation management apparatus as in PTL 1, monitoring needs to be performed by using an appropriate model in accordance with the operating state of the system.

As a technology for switching models according to the operating state at the time of monitoring the system, PTL 2 discloses a monitoring control system that switches models, for predicting occurrence of a bottleneck, triggered by an instruction for changing the configuration of the system, for example. Further, PTL 3 discloses an operation management apparatus that switches models on the basis of a calendar, such as a day of the week.

Moreover, as a related technology, PTL 4 discloses a process monitor apparatus that performs abnormality diagnosis on a process by combining diagnosis results provided by a plurality of models.

### CITATION LIST

### Patent Literature

[PTL 1] Japanese Patent Publication No. 4872944

[PTL 2] Japanese Patent Publication No. 5321195

[PTL 3] Japanese Patent Publication No. 5387779

[PTL 4] Japanese Patent Application Laid-open Publication No. 2012-155361

### SUMMARY OF INVENTION

### Technical Problem

In the case where a system to be monitored is an IT (Information Technology) system, the timing at which the operating state of the system is changed can be acquired on the basis of an instruction for configuration change or a calendar, as in PTL 2 or PTL 3. However, in the case where a system to be monitored is a plant system such as a chemical plant or a steel plant, there are cases where it is difficult to acquire the timing at which the operating state of the system is changed.

For example, in chemical plants, appropriate models vary for individual processes and steps of a chemical reaction. Further, even in each process, appropriate models vary depending on the progress status of the reaction following the supply of chemicals, that is, prior to start of the reaction, during occurrence of the reaction, after the end of the reaction, and the like. Furthermore, the opening and closing of a valve, the supply of chemicals in a process are manually performed at irregular intervals. Therefore, in chemical plants, the timing to switch appropriate models cannot be acquired on the basis of a specific trigger from outside or calendar. In the case where such a plant system is monitored by an operation management apparatus as in PTL 1, it is difficult to perform the monitoring by using an appropriate model in accordance with the operating state of the system.

In the case where the monitoring is not performed with an appropriate model in accordance with the operating state of the system, there is a possibility that abnormality may be notified (an incorrect alarm may occur) even though the system is normally operating.

An object of the present invention is to provide an information processing apparatus, an information processing method, and a recording medium which are capable of solving the foregoing problems and monitoring a system with an appropriate model in accordance with the operating state of the system.

### Solution to Problem

An information processing apparatus according to an exemplary aspect of the invention includes: model storage means for storing a plurality of models relating to monitoring data of a system; and analysis means for performing abnormality detection on newly acquired monitoring data by a main model that is one model among the plurality of models, performing abnormality detection on the newly acquired monitoring data by another model among the plurality of models when abnormality is detected by the main model, and setting the another model as the main model for subsequently acquired monitoring data when abnormality is not detected by the another model.

An information processing method according to an exemplary aspect of the invention includes: storing a plurality of models relating to monitoring data of a system; and performing abnormality detection on newly acquired monitoring data by a main model that is one model among the plurality of models, performing abnormality detection on the newly acquired monitoring data by another model among the plurality of models when abnormality is detected by the main model, and setting the another model as the main model for subsequently acquired monitoring data when abnormality is not detected by the another model.

A computer readable storage medium according to an exemplary aspect of the invention records thereon a program causing a computer to perform a method including: storing a plurality of models relating to monitoring data of a system; and performing abnormality detection on newly acquired monitoring data by a main model that is one model among the plurality of models, performing abnormality detection on the newly acquired monitoring data by another model among the plurality of models when abnormality is detected by the main model, and setting the another model as the main model for subsequently acquired monitoring data when abnormality is not detected by the another model.

### Advantageous Effects of Invention

An advantageous effect of the present invention is that a system can be monitored with an appropriate model in accordance with the operating state of the system.

### BRIEF DESCRIPTION OF DRAWINGS

FIG. 1 is a block diagram illustrating a characteristic configuration of a first example embodiment of the present invention;

FIG. 2 is a block diagram illustrating a configuration of an operation management apparatus 100 in the first example embodiment of the present invention;

FIG. 3 is a block diagram illustrating a configuration of the operation management apparatus 100 in the first example embodiment of the present invention which is realized by a computer;

FIG. 4 is a flowchart illustrating a processing of the operation management apparatus 100 in the first example embodiment of the present invention;

FIG. 5 is a diagram illustrating an example of model information 221 in the first example embodiment of the present invention;

FIG. 6 is a diagram illustrating an example of abnormality detection processing by each of models in the first example embodiment of the present invention;

FIG. 7 is a diagram illustrating an example of a model usage history 222 in the first example embodiment of the present invention;

FIG. 8 is a diagram illustrating an example of an abnormality detection history 224 in the first example embodiment of the present invention;

FIG. 9 is a diagram illustrating an example of a model switchover history 223 in the first example embodiment of the present invention; and

FIG. 10 is a diagram illustrating an example of an output screen 131 in the first example embodiment of the present invention.

### DESCRIPTION OF EMBODIMENTS

### First Example Embodiment

A first example embodiment of the present invention will be described.

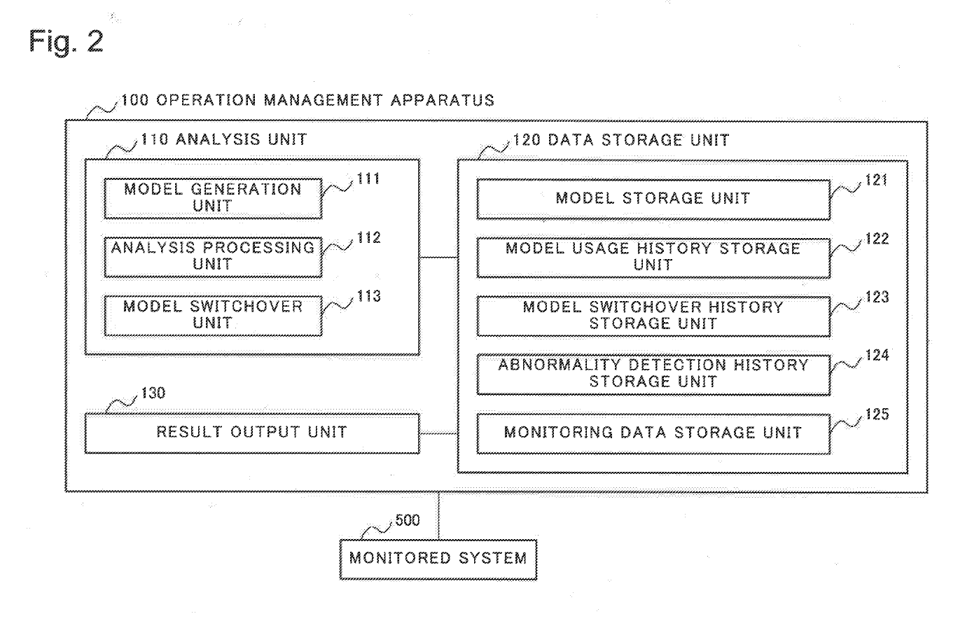

First, a configuration of the first example embodiment of the present invention will be described. FIG. 2 is a block diagram illustrating a configuration of an operation management apparatus 100 in the first example embodiment of the present invention. The operation management apparatus 100 is an example embodiment of the information processing apparatus of the present invention.

Referring to FIG. 2, the operation management apparatus 100 is connected to a monitored system 500 (or simply a system) via a network or the like. The monitored system 500 is, for example, a plant system such as a chemical plant or a steel plant. Further, the monitored system 500 may be a structure such as a bridge. The monitored system 500 may be an IT system that includes one or more computers.

The monitored system 500 measures values of indexes (metrics) that represent the statuses and performances of a plurality of items that are monitoring targets in the system at regular intervals and sends the values to the operation management apparatus 100. Here, for example, electric power, voltage, electric current, temperature, pressure, vibration, and the like that are measured by various kinds of sensors are used as monitoring target items. Further, the usage ratios, usage amounts, and the like of computer resources or network resources, such as CPU (central processing unit) usage ratio, memory usage ratio, disk access frequency, and the like may be used as monitoring target items. Hereinafter, the measured values of a plurality of items of monitoring targets will be referred to as monitoring data.

The operation management apparatus 100 includes an analysis unit 110, a data storage unit 120, and a result output unit 130.

The analysis unit 110 performs various kinds of processing relating to analysis of monitoring data received from the monitored system 500.

The data storage unit 120 stores a time series of the monitoring data received from the monitored system 500 and various histories relating to analysis of the monitoring data.

The result output unit 130 outputs an abnormality notification when abnormality of the monitored system 500 is detected. Further, the result output unit 130 outputs various histories relating to the analysis of the monitoring data stored in the data storage unit 120.

The analysis unit 110 includes a model generation unit 111, an analysis processing unit 112, and a model switchover unit 113.

The model generation unit 111 generates a plurality of models for monitoring from the time series of monitoring data and saves the models in the model storage unit 121.

The analysis processing unit 112 performs abnormality detection on newly acquired monitoring data by a main model selected from among a plurality of models. Further, when abnormality is detected by the main model, the analysis processing unit 112 performs abnormality detection on the monitoring data by a sub-model that is a model other than the main model from among the plurality of models.

On the basis of determination results of the abnormality detection by the main model and the sub-model, the model switchover unit 113 switches the main model to another.

The data storage unit 120 includes a model storage unit 121, a model usage history storage unit 122, a model switchover history storage unit 123, an abnormality detection history storage unit 124, and a monitoring data storage unit 125.

The model storage unit 121 stores a plurality of models generated by the model generation unit 111.

The model usage history storage unit 122 stores a model usage history 222. The model usage history 222 indicates a usage history of a main model by the analysis processing unit 112.

The model switchover history storage unit 123 stores a model switchover history 223. The model switchover history 223 indicates a switchover history of main models by the model switchover unit 113.

The abnormality detection history storage unit 124 stores an abnormality detection history 224. The abnormality detection history 224 indicates a detection history of abnormality of the monitored system 500 in association with the main model at the time of detection of abnormality.

The monitoring data storage unit 125 stores a time series of monitoring data acquired from the monitored system 500.

Note that the operation management apparatus 100 may be a computer including a CPU and a storage medium storing programs, and operating under a control based on a program.

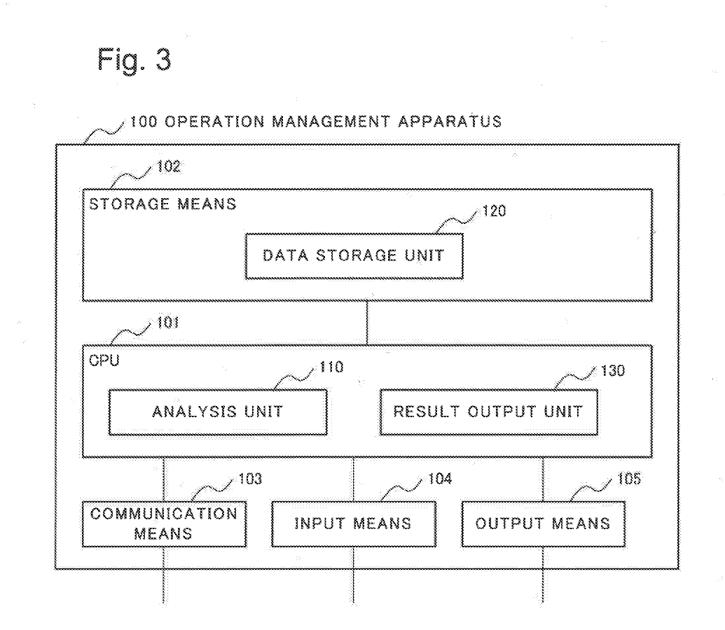

FIG. 3 is a block diagram illustrating a configuration of the operation management apparatus 100 realized by a computer in the first example embodiment of the present invention. The operation management apparatus 100 includes a CPU 101, storage means (storage medium) 102 such as a hard disk or a memory, communication means 103 for performing data communication with another apparatus or the like, input means 104 such as a keyboard, and output means 105 such as a display.

The CPU 101 executes computer programs for realizing the functions of the analysis unit 110 and the result output unit 130. The storage means 102 stores information that is stored in the data storage unit 120. The communication means 103 receives monitoring data from the monitored system 500. The input means 104 accepts, from a user or the like, an instruction to monitor the monitored system 500. The output means 105 outputs (displays) abnormality notification to the user or the like. Further, the output means 105 outputs (displays) an output screen 131 for the user or the like.

Note that the model storage unit 121, the model usage history storage unit 122, the model switchover history storage unit 123, the abnormality detection history storage unit 124, and the monitoring data storage unit 125 of the data storage unit 120 may each be a separate storage medium or may be formed by one storage medium.

Further, the analysis unit 110, the data storage unit 120, and the result output unit 130 may be formed by different apparatuses.

Furthermore, each component of the operation management apparatus 100 may be an independent logic circuit.

Next, the operation of the first example embodiment of the present invention will be described.

Here, the operation will be described with an example of a case where the monitored system 500 is modeled by a correlation model that represents a correlation (relationship) among a plurality of items of monitoring targets (metrics). The monitored system 500 measures values of the plurality of items of monitoring targets at regular intervals and sends the values as monitoring data to the operation management apparatus 100. The time series of the monitoring data received from the monitored system 500 are stored in the monitoring data storage unit 125.

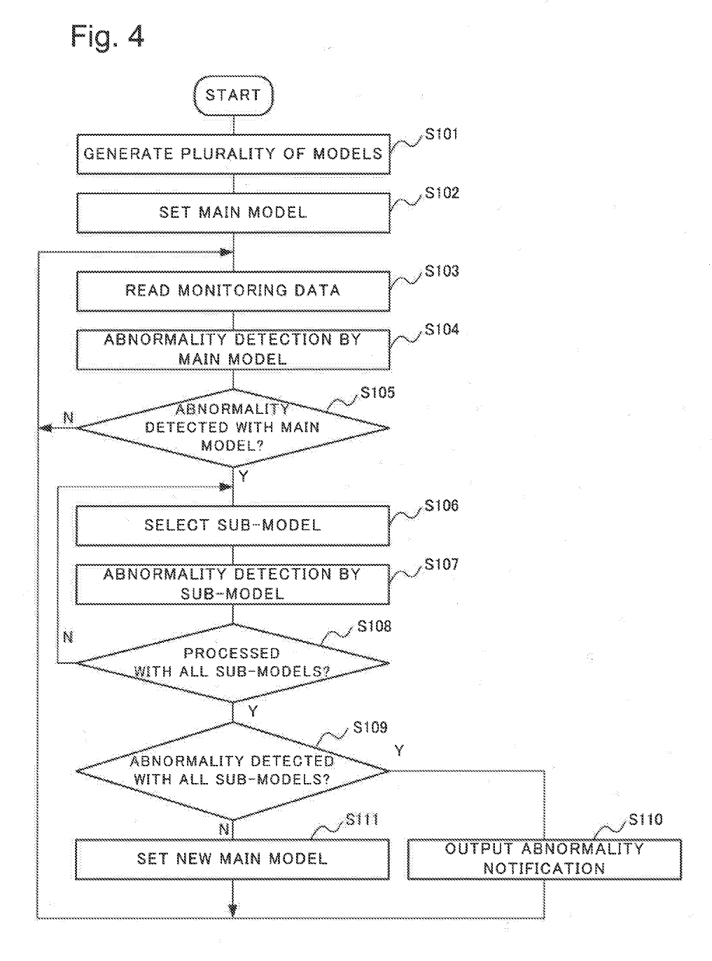

FIG. 4 is a flowchart illustrating a processing of the operation management apparatus 100 in the first example embodiment of the present invention.

First, the model generation unit 111 generates a plurality of models on the basis of the time series of monitoring data stored in the monitoring data storage unit 125 (step S101). The model generation unit 111 saves the generated plurality of models in the model storage unit 121.

For example, similar to the operation management apparatus of PTL 3, the model generation unit 111 generates a plurality of correlation models that each includes one or more correlations between items of monitoring data on the basis of the time series of monitoring data in a period in which the monitored system 500 is normal (at the time of normality) which are stored in the monitoring data storage unit 125.

Here, with respect to each one of a plurality of operating states (processes) of the monitored system 500, the model generation unit 111 generates a correlation model by using the time series at the time of normality in the operating state (process). The time series of which time in the time series of monitoring data is related to which operating state (process) is input, for example, by a user or the like. The model generation unit 111 generates model information 221 in which each operating state (process) is associated with a generated correlation model, and saves the model information 221 together with the correlation models.

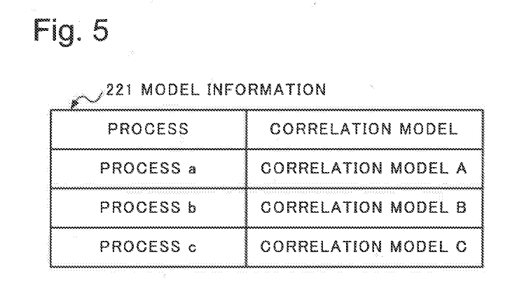

FIG. 5 is a diagram illustrating an example of the model information 221 in the first example embodiment of the present invention.

For example, the model generation unit 111 generates correlation models A, B, and C for processes a, b, and c of the monitored system 500, respectively, to generate the model information 221 as in FIG. 5.

Note that as long as a plurality of correlation models can be generated on the basis of the time series of monitoring data at the time of normality, the model generation unit 111 may generate correlation models without associating the plurality of correlation model with operating states of the monitored system 500. For example, the model generation unit 111 may generate correlation models by using time series of each period of predetermined length (e.g., one day or one hour) in the time series of monitoring data at the time of normality. The predetermined length is set, for example, shorter than the length of a period in which the monitored system 500 continues each operating state. In this case, the model generation unit 111 may integrate similar correlation models among the generated plurality of correlation models into one model.

The analysis processing unit 112 selects an arbitrary model among the plurality of models generated in step S101, and sets the model as a main model (step S102). The analysis processing unit 112 sets models other than the main model as sub-models.

For example, the analysis processing unit 112 sets the correlation model A as a main model and the correlation models B and C as sub-models.

The analysis processing unit 112 reads newly acquired monitoring data from the monitoring data storage unit 125 (step S103).

The analysis processing unit 112 applies the read monitoring data to the main model, and performs abnormality detection using the main model (step S104).

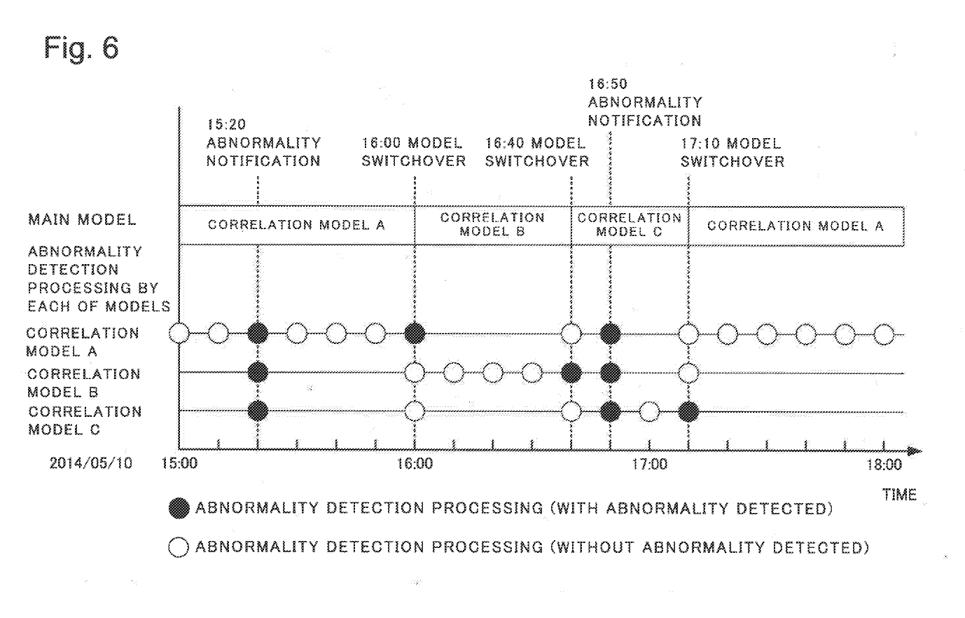

FIG. 6 is a diagram illustrating an example of an abnormality detection process by each model in the first example embodiment of the present invention.

For example, the analysis processing unit 112 applies monitoring data at the time “2014/05/10 15:00” in FIG. 6 to the correlation model A to perform abnormality detection.

Here, similarly to the operation management apparatus described in PTL 1, for example, the analysis processing unit 112 determines that there is abnormality when the number of destructed correlations (correlation destruction) included in the correlation model or the predicted error of the correlations where correlation destruction is detected (a degree of the correlation destruction) is equal to or more than a predetermined threshold value.

Further, the analysis processing unit 112 records the usage history of main model in the model usage history 222.

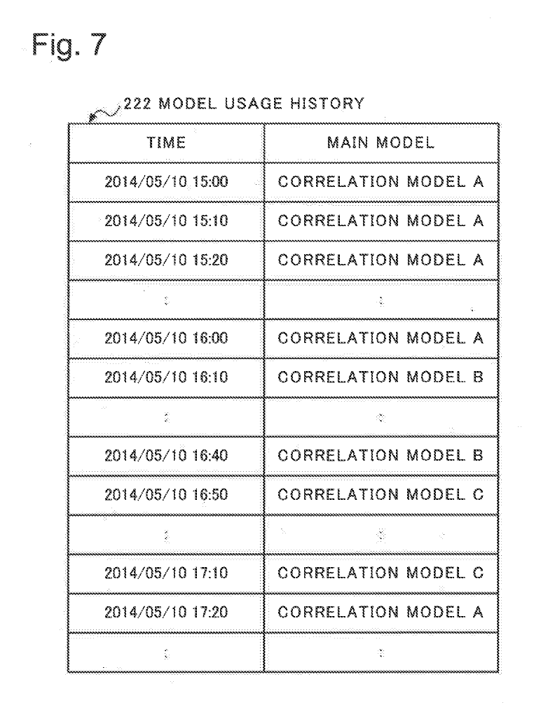

FIG. 7 is a diagram illustrating an example of the model usage history 222 in the first example embodiment of the present invention. For example, the analysis processing unit 112 records the usage history of the correlation model A at the time “15:00” in the model usage history 222, as in FIG. 7.

When abnormality is not detected in step S104 (step S105/N), the analysis processing unit 112 periodically repeats the process from step S103.

For example, when abnormality is not detected with the correlation model A at the time “15:00”, the analysis processing unit 112 applies the monitoring data at the subsequent time “15:10” to the correlation model A to perform abnormality detection. The analysis processing unit 112 records the usage history of the correlation model A at the time “15:10” in the model usage history 222, as in FIG. 7.

Similarly, when abnormality is not detected with the correlation model A at the time “15:10”, the analysis processing unit 112 applies the monitoring data at the subsequent time “15:20” to the correlation model A to perform abnormality detection. The analysis processing unit 112 records the usage history of the correlation model A at the time “15:20” in the model usage history 222, as in FIG. 7.

When abnormality is detected in step S105 (step S105/Y), the model switchover unit 113 selects one of the sub-models and instructs the analysis processing unit 112 to perform abnormality detection by using the sub-model (step S106). The analysis processing unit 112 applies the monitoring data used in step S104 to the sub-model selected in step S106 and performs abnormality detection by the sub-model (step S107). The model switchover unit 113 repeats the process from step S106 with respect to all the sub-models (step S108).

For example, when abnormality is detected with the correlation model A at the time “15:20”, the analysis processing unit 112 applies the monitoring data at the time “15:20” to the correlation models B and C to perform abnormality detection.

The model switchover unit 113 determines whether abnormality is detected with all the sub-models (step S109).

When abnormality is detected with all the sub-models in step S109 (step S109/Y), the model switchover unit 113 determines that abnormality of the monitored system 500 is detected. The model switchover unit 113 outputs an abnormality notification to the user or the like through the result output unit 130 (step S110). Further, the model switchover unit 113 records the detection history of abnormality of the monitored system 500 in the abnormality detection history 224.

For example, when abnormality is detected also with the correlation models B and C at the time “15:20”, along with the correlation model A, the model switchover unit 113 determines that abnormality of the monitored system 500 is detected.

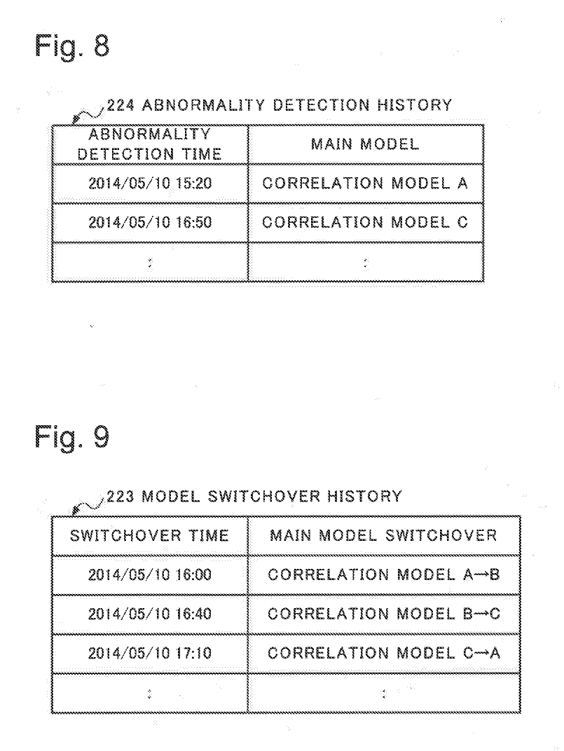

FIG. 8 is a diagram illustrating an example of the abnormality detection history 224 in the first example embodiment of the present invention. For example, the model switchover unit 113 adds a detection history of abnormality of the monitored system 500 at the time “15:20” to the abnormality detection history 224, as in FIG. 8.

When there is a sub-model with which abnormality is not detected in step S109 (step S109/N), the model switchover unit 113 determines that the present main model does not conform to the present operating state of the monitored system 500 and switching of main models is necessary.

The model switchover unit 113 sets the sub-model with which abnormality is not detected as a new main model (step S111). Further, the model switchover unit 113 sets the models other than the new main model as new sub-models. The model switchover unit 113 records the switchover history of main models in the model switchover history 223.

Note that when there exist a plurality of sub-model with which abnormality is not detected, the model switchover unit 113 may set, as a new main model, a sub-model whose degree of conformity is larger than those of the other sub-models. In this case, the degree of conformity is determined to be larger as the number of destructed correlations or the degree of correlation destruction become smaller, for example.

For example, when abnormality is detected with the correlation model A and abnormality is not detected with the correlation models B and C at the time “16:00”, the model switchover unit 113 determines that the switching of main models is necessary. Here, when the correlation model B has a larger degree of conformity among the correlation models B and C, the model switchover unit 113 sets the correlation model B as a new main model and the correlation models A and C as sub-models.

FIG. 9 is a diagram illustrating an example of the model switchover history 223 in the first example embodiment of the present invention. For example, the analysis processing unit 112 adds the switchover history of main models “correlation model A→B” at the time “16:00” to the model switchover history 223, as in FIG. 9.

Subsequently, the process from step S103 is repeated.

For example, when abnormality is detected with the correlation model B at the time “16:40”, the main model is switched from the correlation model B to the correlation model C. Further, when abnormality is also detected with the correlation models A and B at the time “16:50”, along with the correlation model C, abnormality of the monitored system 500 is detected. Furthermore, when abnormality is detected with the correlation model C at the time “17:10”, the main model is switched from the correlation model C to the correlation model A.

As a result, the usage history of main models, detection history of abnormality of the monitored system 500, and the switchover history of main models are recorded in the model usage history 222, the abnormality detection history 224, and the model switchover history 223 as in FIG. 7, FIG. 8, and FIG. 9.

Further, the result output unit 130 outputs the model usage history 222, the model switchover history 223, and the abnormality detection history 224 stored in the data storage unit 120, according to requests from the user or the like.

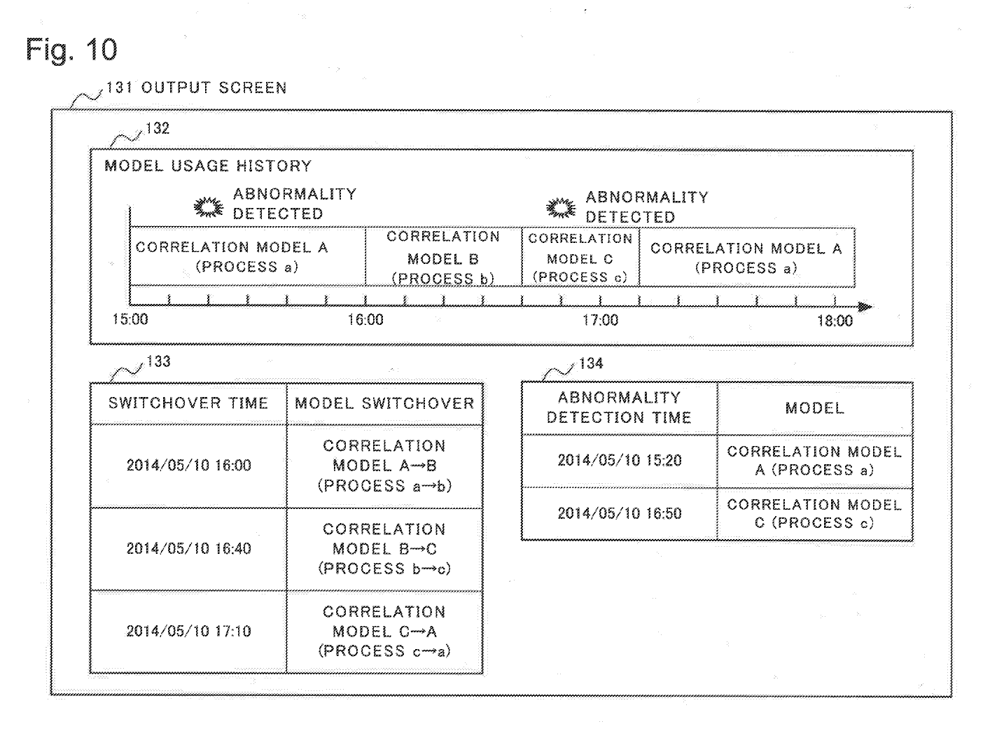

FIG. 10 is a diagram illustrating an example of the output screen 131 in the first example embodiment of the present invention. In the example in FIG. 10, the output screen 131 includes a model usage history display region 132, a model switchover history display region 133, and an abnormality detection history display region 134. The model usage history display region 132 indicates the usage history of main models up to the present time in the model usage history 222. The model switchover history display region 133 indicates the switchover history of main models in the model switchover history 223. The abnormality detection history display region 134 indicates the detection history of abnormality of monitored system 500 in the abnormality detection history 224, in association with the main model at the time of abnormality detection.

Note that the result output unit 130 may output the operating states (processes) that are respectively related to the correlation models indicated in the model information 221, in association with the respective correlation models, on the model usage history display region 132, the model switchover history display region 133, and the abnormality detection history display region 134.

In the example in FIG. 10, the processes that are respectively related to the correlation models indicated in the model information 221 in FIG. 5 are output in association with the respective correlation models.

Due to this, the user or the like can grasp the processes of the present system. Further, the user or the like can compare the time lengths respectively needed for the processes at the time of normality with the time lengths of processes that are respectively related to the correlation models displayed in the model usage history display region 132. The user or the like can then grasp whether each process of the system is being performed normally. Further, the user or the like can compare the transition of the processes at the time of normality with the transition of processes that are respectively related to the correlation models displayed on the model switchover history display region 133. The user or the like can then grasp whether the transition of the processes of the system is being performed normally. Furthermore, the user or the like can grasp in which process abnormality of the system is detected.

Still further, when the time lengths respectively needed for the processes of the system at the time of normality are input beforehand by the user or the like, the result output unit 130 may output, to the model usage history display region 132, results of comparing the input time lengths with the respective time lengths of the processes on the model usage history display region 132. Similarly, when the transition sequence of the processes of the system at the time of normality is input beforehand by the user or the like, the result output unit 130 may output, to the model switchover history display region 133, a result of comparing the input sequence with the transition sequence of the processes on the model switchover history display region 133.

With what has been described above, the operation of the first example embodiment of the present invention is completed.

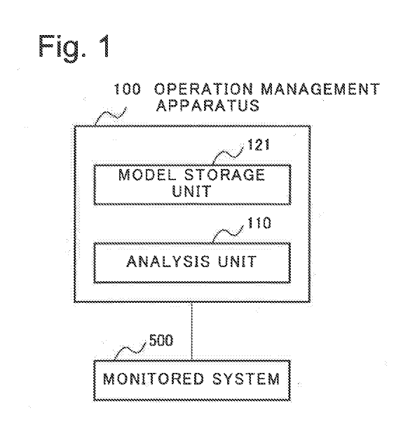

Next, a characteristic configuration of the first example embodiment of the present invention will be described. FIG. 1 is a block diagram illustrating a characteristic configuration of the first example embodiment of the present invention.

Referring to FIG. 1, an operation management apparatus 100 (information processing apparatus) in the first example embodiment of the present invention includes a model storage unit 121 and an analysis unit 110.

The model storage unit 121 stores a plurality of models relating to monitoring data of a monitored system 500 (system).

The analysis unit 110 performs abnormality detection on newly acquired monitoring data by a main model that is one model among the plurality of models. The analysis unit 110 performs abnormality detection on the newly acquired monitoring data by another model (sub-model) when abnormality is detected by the main model. The analysis unit 110 sets this another model as the main model for subsequently acquired monitoring data when abnormality is not detected by this another model.

According to the first example embodiment of the present invention, the system can be monitored with an appropriate model in accordance with the operating state of the system. The reason for this is that when abnormality is detected by the main model and abnormality is not detected by another model, the analysis unit 110 sets this another model as a main model for the subsequently acquired monitoring data. This makes it possible to reduce the incorrect alarm that occurs in the case where the system is monitored by using a model that is not appropriate.

Further, according to the first example embodiment of the present invention, the present operating state (process) of the system can be grasped. The reason for this is that the result output unit 130 outputs the operating state (process) that is related to the present main model on the model usage history display region 132.

Furthermore, according to the first example embodiment of the present invention, it can be distinguished whether the time lengths respectively needed for the operating states (processes) of the system is normal and whether the transition of the operating states (processes) is normal. The reason for this is that the result output unit 130 outputs the operating states (processes) that are respectively related to the models used as main models, in association with the models, on the model usage history display region 132 and the model switchover history display region 133.

Still further, according to the first example embodiment of the present invention, it can be grasped that in which operating state (process) of the system, abnormality of the system is detected. The reason for this is that the result output unit 130 outputs the operating state (process) that is related to the main model at the time of abnormality detection on the abnormality detection history display region 134.

### Second Example Embodiment

Next, a second example embodiment of the present invention will be described.

Here, a case where a system to be monitored is a plant such as a chemical manufacturing plant will be described as an example.

In a chemical manufacturing plant, reactions are accelerated and desired products are produced with high purity by, for example, heating raw materials at a predetermined temperature or applying a predetermined pressure to raw materials. Accordingly, adjustments such as opening and closing valves are performed as appropriate. The temperatures or pressures in various portions of the plant can be acquired by sensors, and it is considered that constant relationships are kept among the temperatures or pressures in normal operations. Further, it can be considered that the opening and closing of valves affect temperatures or pressures, and the relationship change according to the states of the valves. However, the opening and closing of valves are performed for adjustment of a reaction rate of a product or safe operations of the plant within prescribed values, for example. Even if the relationships change, different relationships before and after the change are considered to be relationships that hold in a normal operating state.

Therefore, in such a plant that has a plurality of normal but different operating states, applying the operation management apparatus 100 in the first example embodiment of the present invention will reduce the incorrect alarms in the monitoring of the plant.

Next, a configuration of the second example embodiment of the present invention will be described.

In the second example embodiment of the present invention, the monitored system 500 in FIG. 2 is a plant such as the foregoing chemical manufacturing plant.

The monitored system 500 (plant) measures measured values of a plurality of items of sensors (e.g., a temperature sensor or a pressure sensor) at regular intervals (e.g., every one minute) and sends the measured values as monitoring data to the operation management apparatus 100. The time series of the monitoring data received from the monitored system 500 are stored in the monitoring data storage unit 125.

On the basis of the time series of the monitoring data stored in the monitoring data storage unit 125, the model generation unit 111 generates models for a plurality of processes of the plant, respectively, by using the time series of the respective processes at the time of normality. Further, the model generation unit 111 may generate models, for example, by using time series of every one day or every one hour.

The other configurations are substantially the same as those of the first example embodiment of the present invention.

Due to this, in a plant that has a plurality of different normal operating states, a system can be monitored with an appropriate model in accordance with the operating state of the system, and an incorrect alarms can be reduced.

### Third Example Embodiment

Next, a third example embodiment of the present invention will be described.

Here, a case where a system to be monitored is a mobile unit such as an automobile, a motorcycle, a boat, or an airplane will be described as an example.

These mobile units obtain thrust by burning fuel for engines to generate motive power and transmit the power to tires, propellers, and the like via internal mechanisms. It is considered that a constant relationship holds between the fuel consumption amount and the thrust when the mobile unit is operating normally. Further, it is considered that relationships that hold are different according to external environments, that is, air temperature, weather, the roughness condition of the road surface, and the like. However, those different relationships are all considered to be the relationships that hold in normal operating states.

Therefore, in such a mobile unit that has a plurality of normal but different operating states, applying the operation management apparatus 100 in the first example embodiment of the present invention can reduce the incorrect alarms in the monitoring of the mobile unit.

Next, a configuration of the third example embodiment of the present invention will be described.

In the third example embodiment of the present invention, the monitored system 500 in FIG. 2 is a mobile unit such as an automobile, a motorcycle, a boat, or an airplane, as stated above.

The monitored system 500 (mobile unit) measures measured values of a plurality of items of sensors (e.g., a fuel sensor and a speed sensor) at regular intervals (e.g., every one second) and sends the measured values as monitoring data to the operation management apparatus 100. The time series of the monitoring data received from the monitored system 500 are stored in the monitoring data storage unit 125.

On the basis of the time series of the monitoring data stored in the monitoring data storage unit 125, the model generation unit 111 generates models for a plurality of operating states of the mobile unit, respectively, by using the time series of the respective operating states at the time of normality. Further, the model generation unit 111 may generate models, for example, by using time series of every one hour or every one minute.

The other configurations are substantially the same as those of the first example embodiment of the present invention.

Due to this, in a mobile unit that has a plurality of different normal operating states, a system can be monitored with an appropriate model in accordance with the operating state of the system, and incorrect alarms can be reduced.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

For example, although the example embodiments of the present invention use correlation models as an example of models, it is permissible to use, as the models, other models based on a well-known method in the field of statistical processing such as probability models, for example.

This application is based upon and claims the benefit of priority from Japanese Patent Application No. 2014-185022, filed on Sep. 11, 2014, the disclosure of which is incorporated herein in its entirety by reference.

### REFERENCE SIGNS LIST

100 Operation management apparatus

101 CPU

102 Storage means

103 Communication means

104 Input means

105 Output means

110 Analysis unit

111 Model generation unit

112 Analysis processing unit

113 Model switchover unit

120 Data storage unit

121 Model storage unit

122 Model usage history storage unit

123 Model switchover history storage unit

124 Abnormality detection history storage unit

125 Monitoring data storage unit

130 Result output unit

131 Output screen

132 Model usage history display region

133 Model switchover history display region

134 Abnormality detection history display region

221 Model information

222 Model usage history

223 Model switchover history

224 Abnormality detection history

500 Monitored system

1. An information processing apparatus comprising:
a memory storing instructions; and
one or more processors configured to execute the instructions to:
perform abnormality detection on newly acquired monitoring data by a main model that is one model among a plurality of models relating to monitoring data of a system, perform abnormality detection on the newly acquired monitoring data by another model among the plurality of models when abnormality is detected by the main model, and sets the another model as the main model for subsequently acquired monitoring data when abnormality is not detected by the another model.

2. The information processing apparatus according to claim 1, wherein
the one or more processors are further configured to execute the instructions to determine that abnormality of the system is detected when abnormality is detected with all the plurality of models.

3. The information processing apparatus according to claim 1, wherein
when there exist a plurality of models with which abnormality is not detected, a model that is to be set as the main model is determined, based on degree of conformity to the newly acquired monitoring data for each of the plurality of the models with which abnormality is not detected.

4. The information processing apparatus according to claim 1, wherein
the one or more processors are further configured to execute the instructions to output at least one of a model usage history that indicates a history of a model set as the main model together with time length during which the model is set as the main model; a model switchover history that indicates a history of models set as the main model together with a setting sequence; and an abnormality detection history that indicates a detection history of abnormality of the system together with a model that is set as the main model when the abnormality is detected.

5. The information processing apparatus according to claim 4, wherein
the system is a plant system,
the plurality of models are respectively generated for a plurality of processes of the plant system, and
at least one of the model usage history, the model switchover history, and the abnormality detection history is outputted, in which a process which is related to a model that is set as the main model is associated with the model.

6. An information processing method comprising:
performing abnormality detection on newly acquired monitoring data by a main model that is one model among a plurality of models relating to monitoring data of a system;
performing abnormality detection on the newly acquired monitoring data by another model among the plurality of models when abnormality is detected by the main model; and
setting the another model as the main model for subsequently acquired monitoring data when abnormality is not detected by the another model.

7. The information processing method according to claim 6, further comprising determining that abnormality of the system is detected when abnormality is detected with all the plurality of models.

8. The information processing method according to claim 6, wherein
when there exist a plurality of models with which abnormality is not detected, a model that is to be set as the main model is determined, based on degree of conformity to the newly acquired monitoring data for each of the plurality of the models with which abnormality is not detected.

9. The information processing method according to claim 6, further comprising outputting at least one of a model usage history that indicates a history of a model set as the main model together with time length during which the model is set as the main model; a model switchover history that indicates a history of models set as the main model together with a setting sequence; and an abnormality detection history that indicates a detection history of abnormality of the system together with a model that is set as the main model when the abnormality is detected.

10. The information processing method according to claim 9, wherein
the system is a plant system,
the plurality of models are respectively generated for a plurality of processes of the plant system, and
at least one of the model usage history, the model switchover history, and the abnormality detection history is outputted, in which a process which is related to a model that is set as the main model is associated with the model.

11. A non-transitory computer readable storage medium recording thereon a program causing a computer to perform a method comprising:
performing abnormality detection on newly acquired monitoring data by a main model that is one model among a plurality of models relating to monitoring data of a system;
performing abnormality detection on the newly acquired monitoring data by another model among the plurality of models when abnormality is detected by the main model; and
setting the another model as the main model for subsequently acquired monitoring data when abnormality is not detected by the another model.

12. The non-transitory computer readable storage medium recording thereon the program according to claim 11 causing the computer to perform the method further comprising determining that abnormality of the system is detected when abnormality is detected with all the plurality of models.

13. The non-transitory computer readable storage medium recording thereon the program according to claim 11 causing the computer to perform the method, wherein
when there exist a plurality of models with which abnormality is not detected, a model that is to be set as the main model is determined, based on degree of conformity to the newly acquired monitoring data for each of the plurality of the models with which abnormality is not detected.

14. The non-transitory computer readable storage medium recording thereon the program according to claim 11 causing the computer to perform the method further comprising outputting at least one of a model usage history that indicates a history of a model set as the main model together with time length during which the model is set as the main model; a model switchover history that indicates a history of models set as the main model together with a setting sequence; and an abnormality detection history that indicates a detection history of abnormality of the system together with a model that is set as the main model when the abnormality is detected.

15. The non-transitory computer readable storage medium recording thereon the program according to claim 14 causing the computer to perform the method, wherein
the system is a plant system,
the plurality of models are respectively generated for a plurality of processes of the plant system, and
at least one of the model usage history, the model switchover history, and the abnormality detection history is outputted, in which a process which is related to a model that is set as the main model is associated with the model.
